(19) United States
(12) Patent Application Publication
(10) Pub. No.: US 2006/0064333 A1
(43) Pub. Date: Mar. 23, 2006

(54) Product availability tracking and notification system and method

(76) Inventors: Anne Marie Razza, Villa Park, IL (US); John Bekas JR., Chicago, IL (US); Brian Zimmer, Chicago, IL (US); David P. Thomas, Chicago, IL (US); Gillian Jetson Tarinelli, Naperville, IL (US); Brent E. Walker, Chesterton, IN (US)

Correspondence Address: WILDMAN HARROLD ALLEN & DIXON, 225 WEST WACKER DRIVE, SUITE 2800, CHICAGO, IL, 60606, US

(21) Appl. No.: 11/231,036

(22) Filed: Sep. 20, 2005

Related U.S. Application Data
(60) Provisional application No. 60/611,330, filed on Sep. 20, 2004.

(51) Int. Cl. G06Q 10/00

(52) U.S. Cl. 705/5

(57) ABSTRACT

A product availability tracking and notification system and method is provided that automatically alerts consumers of product availability, such as air travel fares, that is automatically searched after an initial search is performed which meets the criteria of the user. To obtain current price information, internally generated queries and user generated queries that match trips being tracked with corresponding search criteria are provided. In tracking airfares for a trip, applicable taxes and fees are included to provide the consumer an accurate total cost. Notification of current pricing is displayed and communicated to the user once the product is available at a specified target price and after a predetermined time period if the defined target price is not found. Searches and pricing for multiple traveler types and travel date flexibility are provided.

### CROSS REFERENCE TO RELATED APPLICATION

This application claims priority from U.S. Provisional Application No. 60/611,330 filed Sep. 20, 2004.

### FIELD OF THE INVENTION

The present invention relates to systems and methods for searching, locating and notifying a user of product purchase opportunities, and in particular, air travel purchase opportunities.

### BACKGROUND OF THE INVENTION

Many users reserve, book and purchase their travel arrangements over the Internet. For air travel, most travel related web sites require users to enter the city or airport they are departing from, the city or airport they are traveling to, their date of departure and their date of return. After the search data is entered, the user's computer sends a search request to a web server hosting the web site. The web server receives the request and back-end systems perform searches for itineraries that meet the requirements of the user. The results of the search are then sent by the web server for the web site to the computer of the user where the results are displayed for the user to evaluate. In many instances, the user may desire to find an airline flight, meeting the user's travel criteria (from/to locations, travel dates, etc.) that is available at a lower cost than the lowest price provided in the displayed search results. This often leads to a time consuming process of the user to performing additional searches at different travel related websites or at different times in an effort to find a better flight deal.

Certain travel watching systems are able to automatically track the location search criteria inputted by the user, monitor for airline price changes and alert the users if price changes occur. Such systems, however, often do not provide the user with an accurate total cost that includes all applicable taxes and fees. Moreover, the airfares searched are generally not validated for availability to the specific travel date needs of the user. Other desktop applications have been developed which are able to alert users to updated airfares. However, such desktop-based applications are only able to perform searching when users are logged on to their computers. Additionally, the airfare results do not contain applicable service fees and the user is only able to perform searches for adult travelers. Therefore, a need exists for improved systems and methods of locating and notifying users of travel fares at specific price levels.

### BRIEF DESCRIPTION OF THE DRAWINGS

FIG. 1 is a block diagram of a product availability tracking and notification system.

FIG. 1A is a block diagram illustrating the sub-components of the product monitor component of FIG. 1.

FIG. 2 is a flow chart illustrating the steps of tracking a trip in the system of FIG. 1.

FIG. 3 is a flow chart illustrating the steps of utilizing search results of low fare search requests performed at a host management system to update the fares of tracked air travel trips.

FIG. 4 is a flow chart illustrating the steps of automatically updating a lowest price fare associated with air travel trips tracked by the travel management host system.

FIG. 5 is a flow chart illustrating the steps of notifying users of the current state and price of user tracked air travel trips.

FIG. 6 is a flow chart illustrating the steps of user interaction with a tracked trip notification message and the integration back into a booking process of the host management system.

FIG. 7 is an example of an initial search page in which a user may enter travel requirements.

FIG. 8 is an example of an air travel search results page in which search results may be displayed for an air travel trip meeting specified travel requirements inputted at the initial search page of FIG. 7.

FIG. 9 is an example of a deal tracking page.

FIG. 10 is an example of a deal status page displaying search criteria and results for a specified trip that is being tracked.

FIG. 11 is another example of a deal status page displaying multiple search results for air travel trips being tracked having flexible leave and return dates.

FIG. 12 is an example of a notification message indicating a target price set by a user has been matched.

FIG. 13 is an example of a notification message indicating that continued tracking of a specified trip will expire within a predetermined time frame.

FIG. 14 is an example of a notification message providing updated information related to a specified air travel trip that is being tracked for reduced airfares.

### DETAILED DESCRIPTION

A system and method for providing users accessing a website, associated with a product host management system, the ability to have designated products monitored is shown and described. The ability to search for a product meeting specified criteria at lower prices through the employment of an automatic deal detection tracking tool is provided. In the context of the present specification, “products” may encompass services as well as tangible goods. By way of example only, the present specification describes embodiments related to searching and tracking of travel related products and, in particular, airfares for flights meeting selected criteria. However, it is understood that the present invention may encompass and apply to various products and is intended to be covered by the appended claims and their equivalents.

As will be shown and described below, when users perform a flight search via a website associated with a host management system, they are presented with the option to activate a deal tracking application which will allow the user to enter desired target price information for a specified trip. Once fare tracking for the trip is initiated, the deal tracking application will update the current price of the airfare (obtained from flight search results) at predetermined time intervals in an effort to match a desired target price of the user for the air travel trip. For instance, the search results for the tracked trip may selectively be updated with the current price of the air travel trip every 24 hours. Notification messages are sent to the user relating to the specific trip that is being tracked. The notification messages may include periodic updates of the current airfare price, notification that continued tracking of the specified trip will expire soon, and notification when a target price set by the user has been matched. The notification messages may be transmitted to the user via electronic mail (e-mail) and such messages allow the user to seamlessly return to the travel related website of the host system with the appropriate search results for the trip being tracked.

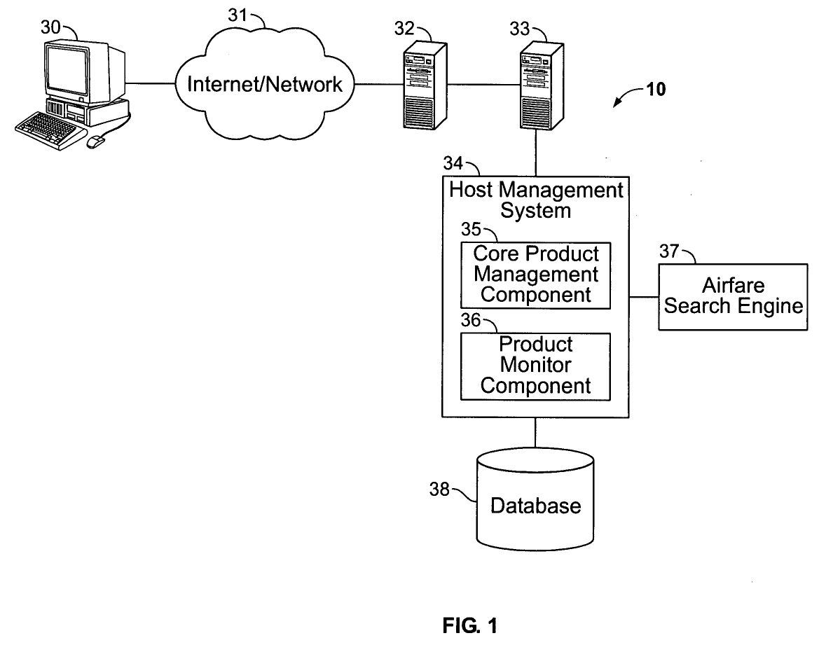

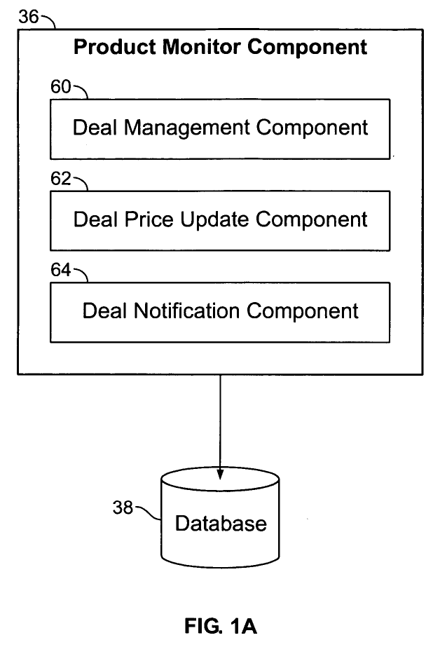

System 10 for tracking product availability and pricing and for notifying users of product price and availability according to an embodiment of the invention is shown in FIG. 1. In this example, system 10 is an Internet based system in which users search for fares and book air travel tickets from their own World Wide Web enabled user communication device 30 or other software enabled display device. User communication device 30, in this example, includes a web browser program, which will allow a user to communicate over the Internet 31 (or other communication network) to a web server 32 which returns content back to the user communication device 30 via the Internet 31. For example, a customer desiring to purchase air travel tickets uses the user communication device 30 to contact web server 32.

Web server 32 is a dedicated web server adapted to provide a network interface between the user and a host management system 34. The web server 32 serves web pages to the user communication device 30 which are displayed by the web browser at the user communication device. Web server 32 likewise receives input data entered by the user through user communication device 30 and transmitted to the web server 32 over the network 31. Much of the content displayed in the various web pages sent to the user communication device 30 from web server 32 is generated by host management system 34 based on communications between the web server 32 and user communication device 30. However, the processing for generating the content and for carrying out instructions entered by the customer is performed by backend systems which are transparent to the user.

Web server 32 includes application layer 33 (preferably embodied in an application server) which acts as an interpreter between the World Wide Web environment of the web server 32 and the user communication device 30, and the backend systems that carry out the core logic and product monitoring processes of the host management system 34. The backend system components include the host management system 34 having a core product management component 35 and a product monitor component 36, airfare search engine 37, and persistent database 38.

The computer controlled host management system 34 of FIG. 1 represents a logical grouping of components that provide searching and booking capabilities, including, for example, such capabilities initiated through the travel related website associated with the host system. Software based subcomponents of the host management system 34 include the core product management component 35 and the product monitor component 36. The functionality of the core product management component 35 represents the base set of logic that allows users of the host system website to register, login, search for travel, book travel, and manage their profile. The product monitor component 36 provides the processing functions that are specific to the creation, management, updating, and notification of fare tracking for a specified trip. The host management system 34 communicates with the persistent database 38 and the airfare search engine 37 (e.g. low fare search engine) to process flight searches and manage user profiles. The product monitor component 36 of the host management system 34 utilizes the persistent database storage 38 and the airfare search engine 37 to manage and update specified trips that are being tracked for airfare prices by the product monitor component 36.

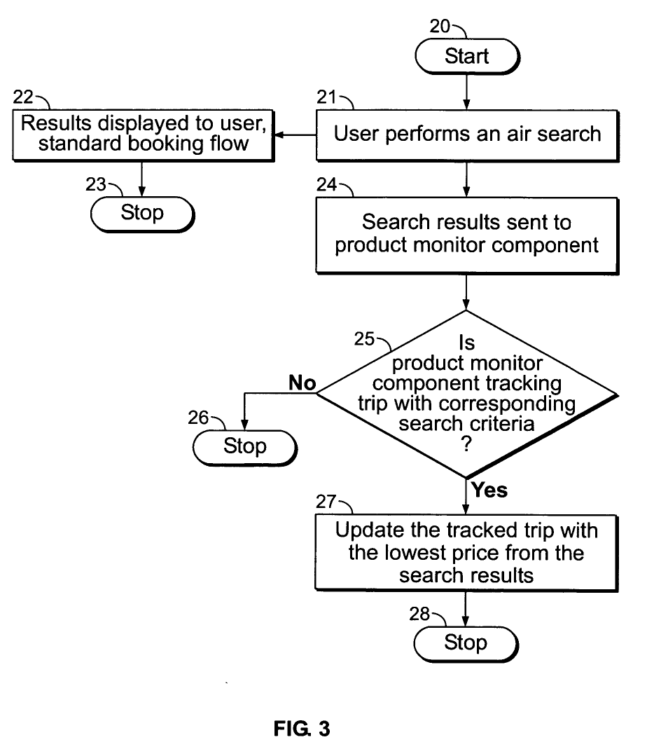

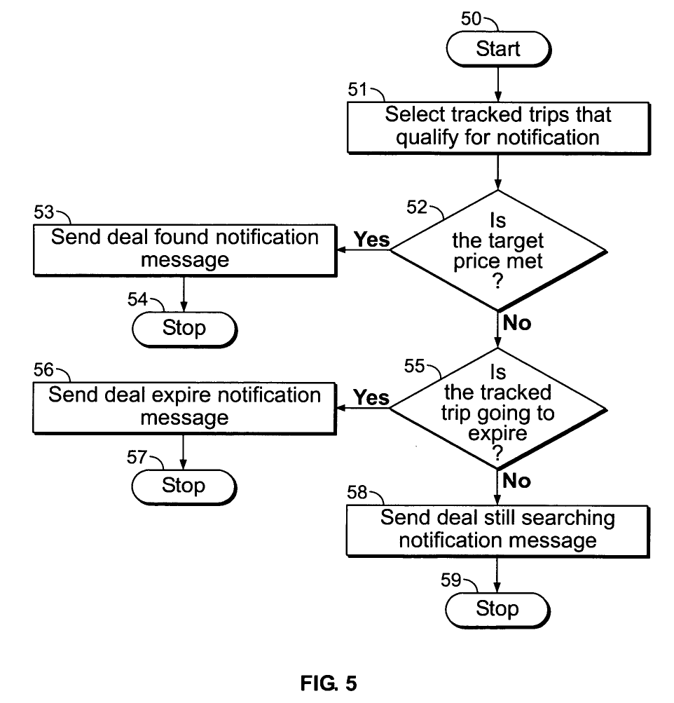

Referring now to FIG. 1A, the sub-components of the product monitor component 36 for the host management system 34 of FIG. 1 are shown. The product monitor component 36 has a deal management component 60 that performs the necessary actions to create, edit and view air travel trips that are being tracked. Once a record has been created to track a specified trip having pre-selected trip criteria, a deal price update component 62 monitors when the last time the air travel pricing for the trip being tracked was previously updated. If needed, the deal price update component 62 also receives updates of air travel fares obtained from the airfare search engine 37 as a result of searches performed on behalf of third parties for trips having matching search criteria as described in FIG. 3. A deal notification component 64 of the product monitor component 36 monitors the state of active trips being tracked and sends notification messages to the user communication device 30 about the status of the trips being tracked on behalf of the user as described further with reference to FIG. 5.

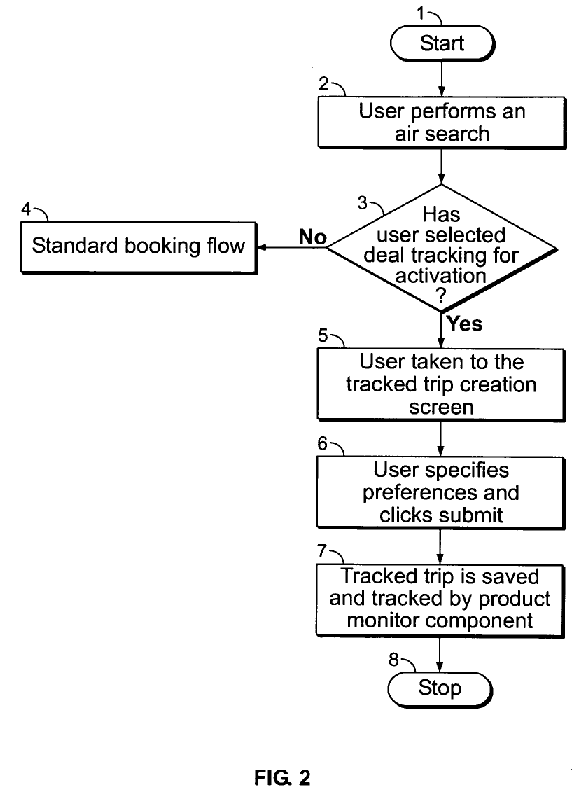

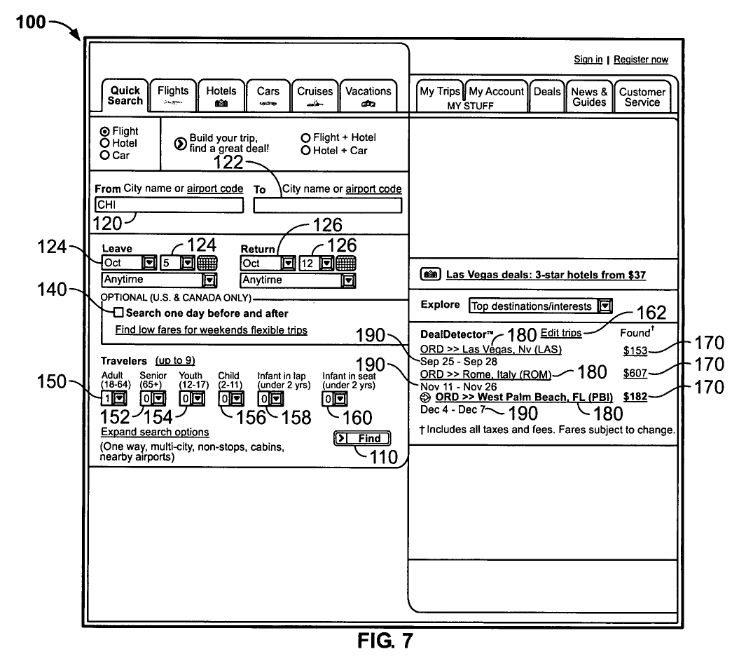

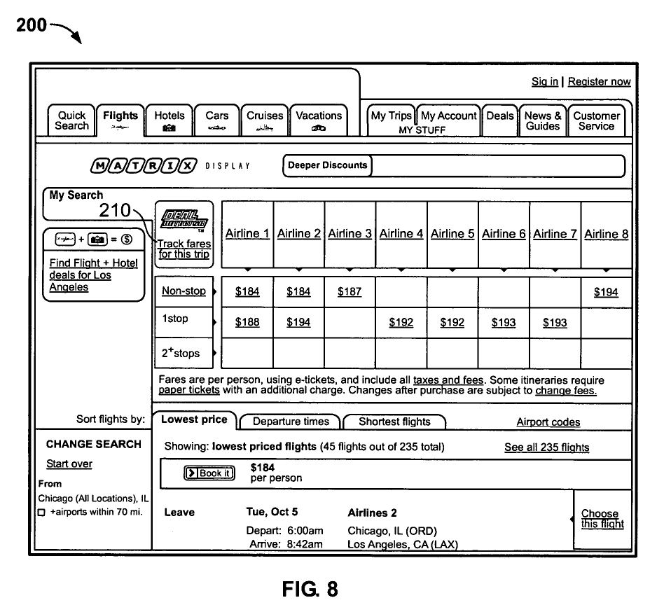

Referring now to FIG. 2, a flow chart illustrating the steps of tracking an air travel trip having pre-selected trip criteria using the system 10 is shown. In step 1, a user at user communication device 30 initiates a session on the web server 32 to access the website associated with the host management system 34. In step 2, the user performs a low airfare search request by inputting travel requirement information (such as the city or airport code they will be departing from and traveling to, leave and return dates, the number and types of travelers, among other travel search criteria) into an initial search page 100 as seen with reference to FIG. 7. Upon user activation of a FIND button 110 displayed on the initial search page 100, FIG. 7, a low airfare search is performed following the inputted requirements and a search results page 200, FIG. 8, is provided displaying the search results. Once the user performs a low fare search request, the user is presented, as seen in FIG. 8, with various flight options based on the air carrier, price, and number of stops. The flight search results screen 200, FIG. 8, displayed at the user communication device 30 includes a deal tracking hyperlink 210 which will allow the user to activate fare tracking for the specified trip meeting the inputted flight search criteria.

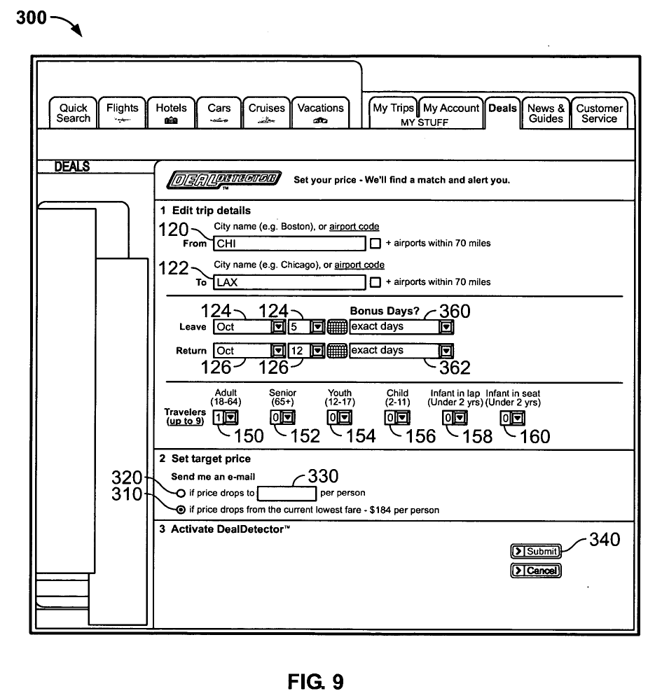

In step 3, FIG. 2, the host system 34 determines if the user has interacted with the deal tracking hyperlink 210, FIG. 8, to activate a tracked trip. If the user does not interact with the deal tracking hyperlink 210, the processing moves to step 4, FIG. 2, and standard booking process flow is performed through the core product management component 35, FIG. 1, of the host management system 34. The standard booking process of step 4, FIG. 2, does not involve interaction with the product monitor component 36 to perform additional fare tracking for the specified trip. If the user chooses to interact with the deal tracking hyperlink 210, FIG. 8, then the processing moves to step 5 and the user is taken to a deal tracking page 300, as seen in FIG. 9, whereby the user may initiate fare tracking for the specified trip. The processing for creating and initiating trips having pre-selected trip criteria to be tracked for fare changes is performed by the deal management component 60, FIG. 1A, of the product monitor component 36. The pre-selected criteria may be one or more aspect or piece of information for describing or identifying a product. For instance, trip criteria for a travel trip product may include origin, destination, travel dates, fares, passenger mix, passenger numbers and the like.

In step 6, FIG. 2, the user interacts with the deal tracking page 300, FIG. 9, appearing at the user communication device 30. The travel preferences of the user are specified in step 6. There are several options the user can select in creating a tracked trip. Applicable trip options are pre-selected from the originating search request performed in step 2. Pre-populating the deal tracking page 300, FIG. 9, alleviates the need for the user to re-enter certain trip criteria information such as origin, destination, travel dates and passenger mix (e.g. adult, senior, youth, child, infant in seat, infant in lap, etc.). Information inputted and displayed at the deal tracking page 300, FIG. 9, may also be selectively edited by the user through user interaction at communication device 30.

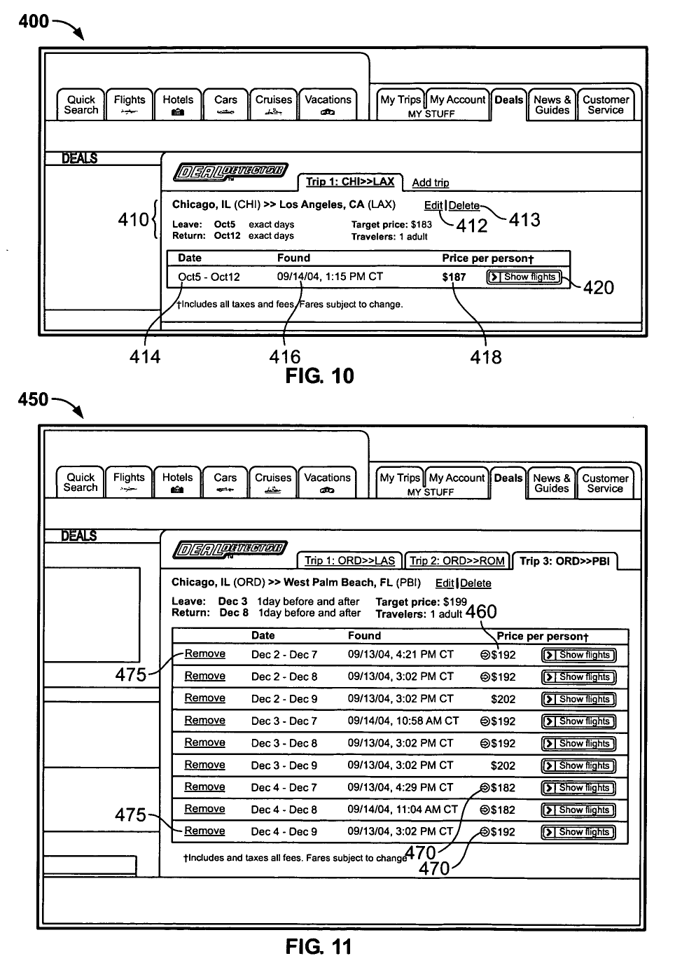

The product monitor component 36, FIG. 1, will also use the lowest airfare price obtained as a result of the original search performed in step 2, FIG. 2, to provide the user with the option of tracking the trip for at least $1.00 less than the current lowest price. This is performed by the user selecting radio button 310, FIG. 9, which results in the product monitor component 36 tracking trips based on a target price that is lower than current fares. The user also has the option to enter a free form target price for the trip by selecting radio button 320 on the deal tracking page 300, FIG. 9, and entering a price in price text field 330 in order for the product monitor component 36 to track trips based on the target price entered by the user. Once all trip criteria has been inputted at the deal tracking page 300 the user clicks a SUBMIT button 340 at the deal tracking page to save the defined trip criteria and initiate tracking of the trip for fare changes by the product monitoring component 36. Upon activating the submit button 340, FIG. 9, a deal status page 400, as seen for example in FIG. 10, is displayed at the user communication device 30 showing the travel criteria and the pricing results for the tracked trip.

As seen in FIG. 10, the deal status page 400 includes a tracked trip criteria field 410 which displays leave and return locations (including airport code), leave date, return date, bonus days selection (if applicable), target price and total number of travelers. An edit link 412 allows for editing of the tracked trip. Activating edit link 412 will display deal tracking page 300, FIG. 9, with trip information pre-populated which can be overtyped and edited by the user. Activation of delete link 413 will delete the specified trip from being tracked by the product monitor component 36 if the user has logged in and been validated by the host management system 34. A date field 414 displays leave and return dates including all variations if a bonus days option is applicable. A found field 416 indicates when the fare for the specified trip was found. The price field 418 displays the last-found fare price, per person, including applicable taxes and fees. A show flights button 420 displays the search results for the trip.

Information regarding specified trips that are being tracked is also displayed at the initial search page 100 of FIG. 7 for registered users that have logged into the host management system 34. For instance, an edit trip link 162 is provided which, upon selection, returns the user to a deal status page, FIGS. 10, 11, displaying tracked trip information. A price link 170, seen in FIG. 7, displays the last-found price, per person, including taxes and fees. A cities link 180, FIG. 7, displays the from/to cities of tracked trips. Activation of link 170 or link 180 communicates with the airfare search engine 37 to perform an airfare search with the search parameters specified for the tracked trip and displays search results page 200 as seen in FIG. 8. A dates element 190 is also displayed at the initial search page 100, FIG. 7, which displays the leave and return dates for the specified trip.

In step 7, FIG. 2, the inputted information for the trip to be tracked is saved. The deal management component 50, FIG. 1A, performs the processes of gathering all user input, validating the user input, and creating appropriate entries in the database 38 to represent a specified trip to be tracked. In step 8, the process of creating and defining a trip to be tracked for alternative air travel fares ends. Once the trip having the specified trip criteria set forth in the deal tracking page 300, FIG. 9, has been created, tracking of the trip will take place.

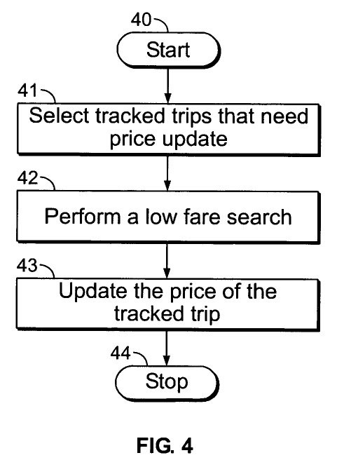

Referring now to FIG. 3, a flow chart illustrating the steps of utilizing user generated search results from low fare search requests for the host management system 34 to update a listing of fares of air travel trips being tracked by the product monitor component 36 is provided. In an effort to take advantage of the large amount of user initiated air travel searches on the host management system 34, the product monitor component 36 utilizes a mechanism in which the results of user initiated airfare searches from the core product management component 35 are sent to the product monitor component 36. User inputted trip criteria is received at the product management component 35 and a search is performed for the user defined air travel trip based on the user inputted criteria. The product monitor component 36 then receives the results of the user defined air travel trip. The product monitor component 34 determines if the user imputed trip criteria corresponds with the trip criteria for the air travel trip being tracked for fare changes. If the product monitor component 36 is tracking a specified trip which matches the parameters of the results from a user initiated search, the current airfare stored for trip being tracked is updated. This process allows the product monitor component 36 to limit the number of proactive system initiated searches (as described with reference to FIG. 4) needed to maintain each of the trips being tracked with current and up to date information.

The processing starts at step 20, FIG. 3, upon a user at communication device 30 initiating a session on the web server 32 and accessing the website associated with the host management system 34. In step 21 a user performs a low airfare search request, for example as described above in step 2, FIG. 2, by entering flight search criteria via the web server 32 to the host management system 34. Two sub-processes are generated at step 21: one that involves user interaction in step 22; and one that is automatically generated by the host management system 34 for the product monitor component 36. Once the user performs a low airfare search request in step 21, as seen for example in FIG. 7, the user is presented with various flight options based on air carrier, price and number of stops. In step 22, the results of the user initiated low airfare search request are displayed to the user at communication device 30 (such as in the example search results page as seen in FIG. 8) and the user may selectively continue the booking process following the standard booking operation of the core product management component 35. No indication is made to the user by the host management system 34 that the search results returned for display at user communication device 30 are also being sent to the product monitor component 36. The processing involving user interaction ends at step 23, FIG. 3, upon the user leaving the website for the host management system 34.

In step 24, FIG. 3, the search results (as presented to the user in step 22) are sent from the core product management component 35 to the product monitor component 36. The process of sending the search results to the deal management component 60, FIG. 1A, of the product monitor component 36 does not impact the user interaction or performance within the standard booking process as discussed in step 22. The results of the user initiated airfare search are sent to the product monitor component 36 through an asynchronous mechanism.

In step 25, the product monitor component 36 determines if there is a trip that is being tracked within the deal management component 60, FIG. 1A, that matches the parameters of the search results received from the core management component 35 of the host system 34. In step 26, if fare tracking for a trip does not exist within the product monitor component 36 that directly corresponds with the search results sent in step 24 from the host management system 34, the flow ends and the search results are discarded. If the product monitor component 36 has a trip being tracked that corresponds to the search results then the processing moves to step 27. In step 27, the current fare for the trip being tracked is updated by the deal price update component 62, FIG. 1A, with the lowest price from the search results sent by the host management system 34. In step 27, FIG. 3, the lowest fare meeting the trip search criteria is updated at the deal price update component 62 without requiring any proactive processing by the product monitor component 36. The product monitor component 36, FIG. 1, is able to take advantage of the search effort and search results that were performed by the core product management component 35 at the host management system 34. The processing ends at step 28 once the current fare for the specified tracked trip is updated by the deal price update component 62, FIG. 1A.

Referring to FIG. 4, a flow chart illustrating steps performed by the product monitor component 36 to automatically update a current or latest searched price of a trip tracked for airfare pricing is provided. In addition to the process for refreshing the current price of specified trips being tracked as described above with reference to FIG. 3, the product monitor component 36 is programmed to proactively search and access information, at predetermined time intervals, for the current lowest price for a specified trip being tracked. Automatically generated searches, at predetermined time intervals (e.g. every 24 hours), are initiated to identify current lowest fares for the air traveled trips being tracked. In step 40, the process to update the current price of a trip being tracked for airfare rates is initialized at the product monitor component 36. In step 41, the deal price update component 62, FIG. 1A, performs the process of inspecting all trips being tracked by the product monitor component 36 to determine which trips have not had the lowest price (associated with the particular trips) updated within a predetermined period of time; for instance within the previous 24 hours. If a trip that is being tracked for airfare deals has not had the lowest price that is associated with that trip updated (via an airfare search) within the predetermined period of time (e.g. 24 hours), those tracked trips identified are selected by the product monitor component 36 and sent to the deal price update component 62 in step 41.

In step 42, one or more low fare search requests are created based on the specified parameters of the associated trips being tracked. The search requests are sent from the product monitor component 36 to the airfare search engine 37, FIG. 1. Once the low airfare search request is created, it is then executed to retrieve the lowest fare for the specified trip being tracked. Once the low airfare search request results are returned from the airfare search engine 37 to the deal price update component 62, FIG. 1A, in step 43 the deal price update component updates the lowest fare associated with the trip being tracked. The processing flow ends in step 44 after the lowest fare has been updated.

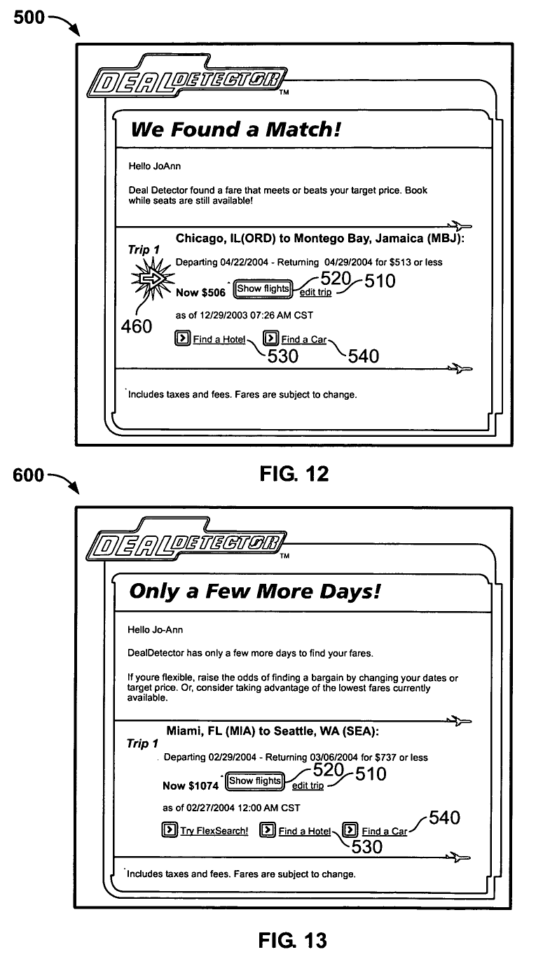

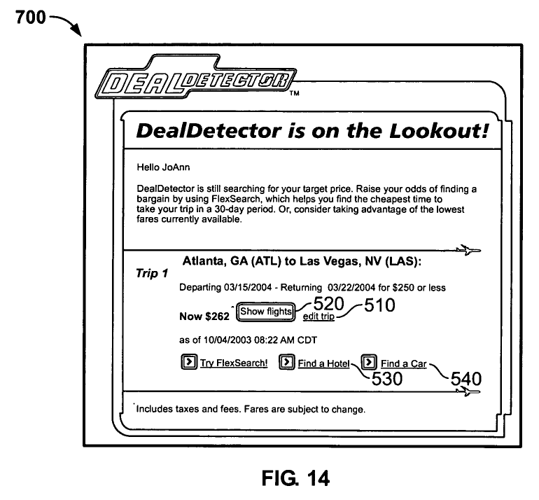

Referring now to FIG. 5, a flow chart illustrating the steps of notifying users of the current status of user tracked air travel trips is provided. To proactively communicate to users the status of specified trips that are being tracked by the product monitor component 36, notification messages are sent to users (having associated user communication devices) regarding the status of their trips that are being tracked for alternative airfare prices. In one example, the notification messages are sent as electronic mail (e-mail) messages from the host management system 34, FIG. 1, via the communication network 31 to the user communication device 30; however, the notification messages sent may be in alternative formats (such as pager messages, text messaging to wireless communication devices, instant messenger messages, facsimile or phone) for receipt at various user communication devices in such alternative formats. For purposes of this example only, the notification messages will be described as e-mail messages. The types of notification messages which may be transmitted to the user communication device 30 include a target price met message 500 (FIG. 12); a deal expire messages 600 (FIG. 13); and a still searching message 700 (FIG. 14).

The process to send notification messages based on the status of a specified trip being tracked by the product monitor component 36 to user communication device 30 is initialized in step 50, FIG. 5. In step 51, the product monitor component 36 selects all stored trips being tracked that qualify for message notification. Conditions which determine if a particular air travel trip being tracked qualifies to have a message sent to the user having a trip being tracked on the user's behalf include: whether the target airfare price for the specified trip is at or below the current fare price; whether the user has not been updated on the status of the tracking of the specified trip within a predetermined time period; and whether the fare tracking of the specified trip will expire based on the date of departure.

In step 52, the deal notification component 64, FIG. 1A, of the product monitor component 36 determines if the current airfare price is at or below the specified target price set by the user. If the target price has been met, then in step 53, the deal notification component 64 transmits a notification message 500, FIG. 12, indicating that the target price for the trip being tracked has been met. In step 54, FIG. 5, the processing for the deal found notification messaging comes to an end.

If the target price has not been met in step 52, FIG. 5, the processing moves to step 55 in which the deal notification component 64, FIG. 1A, determines if a specified trip being tracked is going to expire based on the departure date of the trip. If the trip being tracked is going to expire within a predetermined amount of time of the trip departure date, then the processing moves to step 56 and the deal notification component 64 transmits a notification message 600, FIG. 13, indicating the trip being tracked is about to expire. In step 57, FIG. 5, the processing for the deal expiration notification messaging comes to an end.

If the trip being tracked by the product monitor component 36 is not going to expire as determined in step 55, then the processing moves to step 58. In step 58, FIG. 5, the deal notification component 64, FIG. 1A, sends the user communication device 30, associated with user having the trip tracked, a notification message 700, FIG. 14. The notification message 700, FIG. 14, provides information about the current status of the trip being tracked and provides information to the user that airfare searching (by the host system 34) for the target price specified by the user is still being performed. In step 59, FIG. 5, the processing for the deal still being searched notification messaging comes to an end.

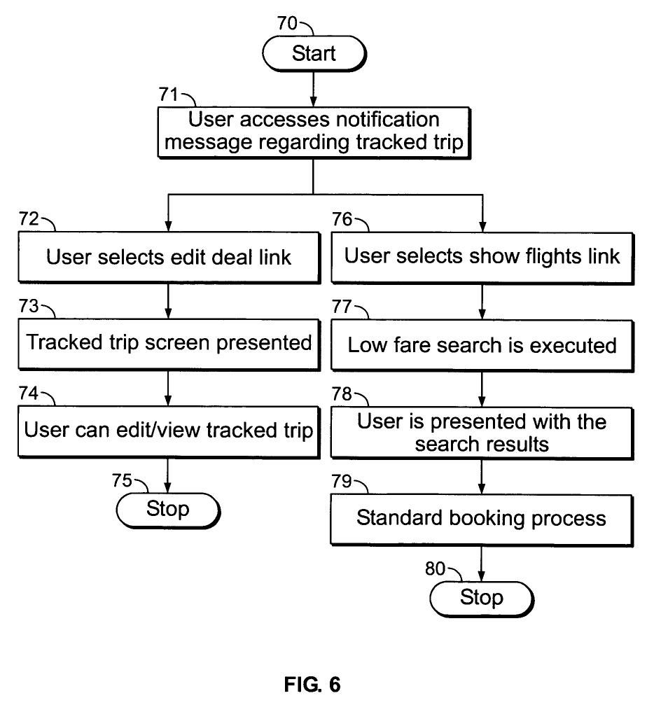

Referring now to FIG. 6, a flow chart illustrating the steps of user interaction with tracked trip notification messages and the integration back into the standard booking process executed by the core management component 35 of the host management system 34 is provided. FIG. 6 illustrates the close interaction and seamless integration of the notification messages 500, 600 or 700 (FIGS. 12, 13, 14 respectively) generated by the deal notification component 64, FIG. 1A, and the booking process performed at the core management component 35, FIG. 1. In step 70, FIG. 6, the processing begins upon receipt by a user of a notification message 500, 600 or 700 (such as an electronic mail message) at user communication device 30, FIG. 1. Preferably, the user is a registered user/member of the website associated with the host management system 34 and the user communication device 30 is a device designated by the user to receive notification messages and other information from the host management system. In step 71, FIG. 6, the user at communication device 30 opens the notification message 500, 600 or 700 received from the deal notification component 64 of the host management system 34. The process flow of FIG. 6 applies to each of the exemplary notification messages 500 (FIG. 12), 600 (FIG. 13) and 700 (FIG. 14) described above with reference to FIG. 5.

In step 72, FIG. 6, the user from communication device 30 selects an edit link 510 (FIGS. 12-14) from the notification message received from the product monitor component 36. In step 73, the product monitor component 36 retrieves information related to the trip being tracked that is associated with the notification message for display at the user communication device 30. Selection of an edit link 510 (FIGS. 12-14) will cause a browser window to open, as discussed with reference to FIG. 1, and relevant information regarding the details of the tracked trip are displayed to the user at user communication device 30. In particular, a deal tracking page 300, as seen in FIG. 9 for example, is presented to the user at user communication device 30. Once the user is presented with the deal tracking page 300, in step 74, FIG. 6, the user may view the details of the tracked trip on the user communication device 30 or make any revisions to the parameters associated with the tracked trip that are shown on the displayed tracking page. The deal tracking page 300, FIG. 9, is an interactive page which allows the user to make modifications to travel related criteria for a trip being tracked. In step 75, the user leaves the website associated with the host system 34 or exits the deal tracking page 300 thereby ending the processing flow.

In step 76, FIG. 6, the user at communication device 30 interacts with a show flights link 520 (FIGS. 12-14) appearing in the notification message 500, 600 or 700 received from the deal notification component 54, FIG. 1A. If the user selects the show flights link 520 (FIGS. 12-14) in step 76, then in step 77 the product monitor component 36, FIG. 1, communicates with the airfare search engine 37 to perform an airfare search with the search parameters specified for the tracked trip, as previously inputted in the deal tracking page 300, FIG. 9, Additionally, as seen in FIGS. 12-14, each of the exemplary notification messages 500, 600, 700 contains both a hotel find hyperlink 530 and a car find hyperlink 540. The notification messages 500, 600, 700 generated by the product monitor component 36 provide 1-click access to car or hotel search results relative to the air travel trips being tracked upon activation of hyperlinks 530 or 540. Other products (such as vacation packages or attractions and services) can also be included in the notification message 500, 600 or 700.

In step 78, FIG. 6, the user communication device 30 is presented with the flight search results, for example, in a search results page 200 as seen in FIG. 8. Once the user is presented with the search results in step 78, then in step 79, the user is taken into the standard booking process controlled by the core product management component 35, FIG. 1, of the host management system 34 to permit selective booking of an air travel trip. The processing flow ends in step 80 when the user leaves the website associated with the host management system 34 or begins to interact with the core product management component 35 for other non-tracked products.

The product monitor component 36, FIG. 1, is a software based application of the host management system 34 that provides a reminder or call-to-action of an interest in a product, such as airfare for a trip, previously expressed by a user. Ongoing tracking of price and availability information about the product, on behalf of the user, saves the user time. The ongoing tracking also allows a relationship between the user and the business organization operating the host management system 34 to continue without the user returning to the website associated with the host management system to check on current prices. Because the user has provided information to the host management system 34 concerning desired travel criteria (e.g. travel dates, origin/destination, number and types of travelers, and target price), the product monitor component 36 is able to alert the user when an air travel trip meeting the specified criteria is available or periodically advise of current pricing.

The host management system 34 is able to quote the total price including all taxes and fees, for air travel trips meeting the user specified criteria because the product monitor component 36, interacting with the airfare search engine 37, searches for the correct traveler mix on specific dates based on available itineraries for comparison with a target price specified by the user. As seen in both the initial search page 100 of FIG. 7 and the deal tracking page 300 of FIG. 9, passenger type data is entered in passenger type data fields 150, 152, 154, 156, 158, 160 which respectively correspond with adult, senior, youth, child, infant in lap, infant in seat, passenger types. The passenger type data fields may also have drop down menus which allow the number of passengers to be inputted for each passenger type up to a total of nine passengers. Identifying the traveler (passenger) types and the number of travelers is used to accurately calculate the correct airfares and verify the availability of flight options for particular dates. Properly identifying the traveler types ensures the right applicable price and the number of seats needed for an air travel trip.

Additionally, airlines file base airfare rates to which various government and airport taxes and fees apply for United States domestic flights. Certain taxes are constant, such as the U.S. Transportation Tax; and others are dependent on the flight itinerary, such as Passenger Facility Charges, U.S. Flight Segment Tax and the September 11 Security Fee. Other taxes and fees, as required now or in the future, are also included. Service fees for the travel related website company is a separate additional cost. The expectation of target price for the user is generally the maximum price the user is considering to spend for an air travel trip and can be collected on a per person basis (as illustrated) or a cumulative total for all travelers. In determining the total airfare pricing for an air travel trip, the host management system 34 together with the airfare search engine 37 examines the schedules, fares, and availability of airline flights. The host management system 34 includes the applicable taxes and fees in tracking airfares for a specified trip to improve the understanding by the user of the total costs which is generally how a user views their target price for purchasing a ticket.

The host management system 34 provides for tracking of specified air travel trips and current prices based on the specific travel dates inputted by the user as well as additional date flexibility known as a “Bonus Days” option (allowing for travel flexibility before and/or after specific dates). As seen in FIG. 7, the initial search page 100 includes a FROM data field 120 in which the user enters the name of the city or airport code of the airport they will be departing from. Similarly, the user enters the city or airport they will be traveling to in a TO data field 122. A LEAVE data field 124 and a RETURN data field 126 are provided for the user to enter his or her departure and return travel dates. The fields 120, 122, 124, 126 are also provided in the deal tracking page 300 of FIG. 9. The “Bonus Days” option for trip tracking is selected through drop down menus 360, 362 at the deal tracking page 300 seen in FIG. 9. Menu 360 FIG. 9, lists the range of flexible days from the leave date and menu 362 lists the range of flexible days from the return date. For example, the range of flexibility may be from 0 to three days from either the leave date or return date. In this example, when tracking air travel trips and searching for travel itineraries, the host management system 34 identifies one or more departure dates and one or more return dates. Either or both of the departure dates and return dates include multiple dates when the “Bonus Days” option is utilized. Date pairs are formed by the host management system 34 based on every combination of departure date(s) and return date(s). A search is then initiated for travel itineraries and fares for each date pair and the results are displayed at the user communication device 30. By selecting the “Bonus Days” option, the host management system 34 expands the trip tracking from one set of travel dates to multiple sets of travel dates provided the user has some flexibility of when to travel.

As seen in FIG. 11, a deal status page 450 is shown displaying multiple search results for air travel trips being tracked having flexible leave and return dates. The deal status page 450, FIG. 11, may be displayed in response to the selection of a “Bonus Days” drop down menu 360, 362 at the deal tracking page 300 of FIG. 9. Upon initiation of a specified trip to be tracked by the product monitor component 36, FIG. 1, in response to activation of the SUBMIT button 340, FIG. 9, multiple search results are displayed on the deal status page 450, FIG. 11, when the “Bonus Days” option is selected. In the example shown in FIG. 11, the deal status page 450 displays airfare price information 460 for the specified leave and return dates as well as pricing information for trips beginning one day before and after the specified leave date and for trips ending one day before and after the specified return date. The product monitor component 36 tracks the applicable travel dates so the user can easily compare low fares across these dates and be alerted via notification messages on pricing for any of these dates. If the product monitor component 36 finds an airfare price for a specified trip being tracked that is the same or lower than the target price inputted by the user, then a graphic indicator 470 is displayed adjacent to the price found indicating the target price has been met. Graphic indicator 470 also applies to price information 418 on the deal status page 400, FIG. 10, and to price information 170 on the initial search page, FIG. 7, when the target price has been met. Activation of remove link 475, FIG. 11, will delete a specific date pair on a trip (including specified bonus days) being tracked by the product monitor component 36. For further details on the “Bonus Days” option, reference can be made to U.S. patent application Ser. No. 10/687,366, for “A Method and System for Searching for Travel Itineraries with Flexible Travel Dates”, filed Oct. 15, 2003, which is hereby incorporated by reference.

As shown herein, the functionality performed by the product monitor component 36 of the host management system 34 saves the user time from searching over-and-over for the same travel criteria, only to be looking for an airfare at a specific price level. The product monitor component 36 also provides a 1-click access to flight options, eliminating the need to re-enter the travel criteria to perform a search request. Airfares and availability of flight options are parts of planning a trip that may change frequently and without warning. Airfares are guaranteed by airlines at the time of purchase and alerting users via notification messages that their target air travel price was found is a strong motivator for making a timely decision to purchasers.

The foregoing description of the preferred embodiments of the invention have been presented for purposes of illustration and description, and are not intended to be exhaustive or to limit the invention to the precise forms disclosed. The descriptions were selected to best explain the principles of the invention and their practical application to enable other skills in the art to best utilize the invention in various embodiments and various modifications as are suited to the particular use contemplated. It is intended that the scope of the invention not be limited by the specification, but be defined by the claims set forth below.

What is claimed is:

1. A system for monitoring fares for air travel trips comprising:
a computer controlled host management system that tracks fare changes for air travel trips having trip criteria;
a product management component coupled with an airfare search engine that performs a search for a user defined air travel trip based on user inputted trip criteria in which the product management component obtains the results of the search for the user defined air travel trip; and
a product monitor component that updates a fare for at least one air travel trip being tracked with results of the search for the user defined air travel trip.

2. The system of claim 1 in which the product monitor component determines if the user inputted trip criteria corresponds with the trip criteria for at least one air travel trip being tracked for fare changes.

3. The system of claim 2 in which the search results are sent from the product management component to the product monitor component to update the fare for at least one air travel trip with the lowest fare price obtained from the search results if the user inputted trip criteria corresponds with the trip criteria for the air travel trip being tracked.

4. The system of claim 3 in which the product monitor component is coupled with the airfare search engine to initiate automatically generated searches to identify current lowest fares for the air travel trips being tracked.

5. The system of claim 4 further comprising a deal price update component of the product monitor component that performs the process of inspecting air travel trips being tracked to identify which trips have not had their associated lowest fare updated within a predetermined period of time.

6. The system of claim 5 in which the product monitor component creates low fare search requests for the identified trips that have not had an associated lowest fare updated within the predetermined time period and sends the low fare search requests to the airfare search engine, and in which the deal price update component updates the lowest fares associated with the identified trips based on the lowest fares found for the identified trips.

7. The system of claim 3 further comprising a deal notification component that sends notification messages regarding the status of the air travel trips being tracked to user communication devices associated with users having air travel trips being tracked.

8. The system of claim 7 in which the product monitor component determines if an air travel trip being tracked qualifies to have a notification message sent to a user communication device by determining at least one of:
(a) that a target airfare price for the air travel trip being tracked is at or below a current fare;
(b) that a user communication device has not received an update on the status of the tracking of the air travel trip within a predetermined time period; and
(c) that fare monitoring for the air travel trip will be expiring within an identified time period.

9. The system of claim 8 in which the notification messages sent by the product monitor component are electronic mail messages having a link that provides integration to a booking process to permit selective booking of the air travel trip via the product management component in response to user interaction with the notification message.

10. The system of claim 9 in which the notification messages have actuatable links which provide access to search results for other travel related products in response to user interaction with the actuatable links.

11. The system of claim 3 in which the host management system identifies traveler types and a number of travelers for the air travel trip being tracked and quotes a total price for the air travel trip including taxes and fees.

12. A method of monitoring fares for air travel trips comprising:
tracking air travel trips having trip criteria for fare changes;
performing a search for a user defined air travel trip based on user inputted trip criteria;
obtaining results of the search for the user defined air travel trip; and
updating a fare for at least one air travel trip being tracked with search results for the user defined air travel trip.

13. The method of claim 12 further comprising determining if the user inputted trip criteria corresponds with the trip criteria for the air travel trip being tracked for fare changes.

14. The method of claim 13 wherein the step of updating further comprises updating the fare for the air travel trip with the lowest fare price obtained from the search results if the user inputted trip criteria corresponds with the trip criteria for the air travel trip being tracked.

15. The method of claim 14 further comprising initiating automatically generated searches to identify current lowest fares for the air travel trips being tracked.

16. The method of claim 15 further comprising inspecting air travel trips being tracked to identify which trips have not had their associated lowest fare updated within a predetermined period of time.

17. The method of claim 16 further comprising creating low fare search requests for the identified trips that have not had an associated lowest fare updated within the predetermined time period;
sending the low fare search requests to an airfare search engine; and
retrieving the lowest fares found for the identified trips and updating the lowest fares associated with the identified trips.

18. The method of claim 14 further comprising sending notification messages regarding the status of the air travel trips being tracked to users associated with the air travel trips being tracked on their behalf.

19. The method of claim 18 further comprising determining if an air travel trip being tracked qualifies to have a notification message sent to the user associated with the trip by determining at least one of:
(a) that a target airfare price for the air travel trip being tracked is at or below a current fare;
(b) that a user has not been updated on the status of the tracking of the air travel trip within a predetermined time period; and
(c) that fare monitoring for the air travel trip will be expiring within an identified time period.

20. The method of claim 19 further comprising providing integration into a booking process to permit selective booking of the air travel trip in response to user interaction with the notification message.

21. The method of claim 19 further comprising performing an automated search for other travel related products in response to user interaction with the notification message.

22. The method of claim 14 further comprising identifying traveler types and a number of travelers for the air travel trip being tracked; and
quoting a total price for the air travel trip including taxes and fees.

23. The method of claim 14 further comprising identifying one or more departure dates and one or more return dates, where at least one of said one or more departure dates and said one or more return dates comprises a plurality of dates;
identifying a plurality of date pairs, each date pair comprising one of said one or more departures dates and one of said one or more return dates; and
searching for fares for itineraries corresponding to each date pair.

24. A system for monitoring product availability comprising:
a computer controlled host management system that automatically tracks the availability of products in accordance with product criteria;
a product management component coupled with a search engine that performs a search for a product identified by user inputted product criteria in which the product management component obtains the results of the search for the product identified by the inputted product criteria; and
a product monitor component that updates a price for at least one product being tracked with search results for the user identified product.

25. The system of claim 24 in which the product monitor component determines if the user inputted product criteria corresponds with the trip criteria for at least one product being tracked.

26. The system of claim 25 in which the search results are sent from the product management component to the product monitor component to update the price for at least one product with the lowest price obtained from the search results if the user inputted product criteria corresponds with the product criteria for the product being tracked.

27. The system of claim 26 in which the product monitor component is coupled with the search engine to initiate automatically generated searches, at predetermined time intervals, to identify current lowest prices for the products being tracked.

28. The system of claim 27 further comprising a deal price update component of the product monitor component to identify which products being tracked have had their associated lowest price updated within a predetermined period of time.

29. The system of claim 28 in which the product monitor component creates price search requests for the identified products but have not had an associated lowest price updated within the predetermined time period and sends the price search request to the search engine, and in which the deal price update component updates the lowest prices associated with the identified products based on the lowest prices found for the identified products.

30. The system of claim 29 further comprising a deal notification component that sends notification messages regarding the status of the product being tracked to user communication devices associated with users having one or more products being tracked.

31. The system of claim 30 in which the product monitor component determines if a product being tracked qualifies to have confirmation messages sent to a user communication device by determining at least one of:
(a) that a target price for the product being tracked is at or below a current price;
(b) that a user communication device has not received an update on the status of the tracking of the product within a predetermined time period; and
(c) that price monitoring for the product will be expiring within an identified time period.

32. The system of claim 31 in which the notification messages sent by the product monitor component are electronic mail messages having a link that provides integration back to the product management component to permit selective purchasing of the product identified in the notification message in response to user interaction with the notification message.
